(19) United States
(12) Patent Application Publication
(10) Pub. No.: US 2015/0242612 A1
(43) Pub. Date: Aug. 27, 2015

(54) HARDWARE TOOLS AND METHODS FOR CAPACITIVE SENSOR ENABLED AUTHENTICATION

(71) Applicant: SnowShoeFood, Inc., Madison, WI (US)

(72) Inventors: Claus Christopher Moberg, San Francisco, CA (US); Matt Luedke, Madison, WI (US); Isaac Ray, Madison, WI (US); Jami Morton, Madison, WI (US); Erland Kelley, Madison, WI (US)

(21) Appl. No.: 14/617,813

(22) Filed: Feb. 9, 2015

Related U.S. Application Data
(60) Provisional application No. 61/937,015, filed on Feb. 7, 2014.
(60) Provisional application No. 62/057,385, filed on Sep. 30, 2014.

(51) Int. Cl. G06F 21/36; G06F 3/044

(52) U.S. Cl. CPC G06F 21/36; G06F 3/044; G06F 2203/04111

(57) ABSTRACT

A hardware tool for authenticating with a capacitive sensor includes a set of capacitive interaction volumes, each including a conductive capacitive contact area and a capacitive body, a dielectric substrate, coupled to the set of capacitive interaction volume, that provides electrical isolation between the capacitive interaction volumes, and a current coupler, electrically coupled to the set of capacitive interaction volumes.

### CROSS-REFERENCE TO RELATED APPLICATIONS

This application claims the benefit of U.S. Provisional Application Ser. No. 61/937,015, filed on 7 Feb. 2014, and U.S. Provisional Application Ser. No. 62/057,385, filed on 30 Sep. 2014, both of which are incorporated in their entireties by this reference.

### TECHNICAL FIELD

This invention relates generally to the consumer electronics field, and more specifically to new and useful hardware tools and methods for capacitive sensor enabled authentication in the consumer electronics field.

### BACKGROUND

As more and more important transactions and events are conducted electronically, the need to authenticate these transactions and events also grows in importance. While software authentication (such as entering a password) allows for identification, security concerns with software authentication have encouraged the growth of hardware authentication. However, current hardware authentication tools and methods are often expensive, inconvenient, or require dedicated sensing hardware (for example, smart card readers). Thus, there is a need in the consumer electronics field to create hardware tools and methods for capacitive sensor enabled authentication. This invention provides such new and useful hardware tools and methods.

### BRIEF DESCRIPTION OF THE FIGURES

FIGS. 1a and 1b are respectively a top view and bottom view of a schematic representation of a hardware tool of a preferred embodiment;

FIGS. 2a and 2b are respectively a top view and bottom view of a schematic representation of capacitive interaction volumes of a hardware tool of a preferred embodiment;

FIGS. 3a and 3b are respectively a top view and bottom view of a schematic representation of subsections of capacitive interaction volumes of a hardware tool of a preferred embodiment;

FIGS. 4a-d are example representations of capacitive interactions of varying capacitive interaction volumes of a hardware tool of a preferred embodiment;

FIG. 5 is a schematic representation of a hardware tool of a preferred embodiment;

FIGS. 6A and 6B are plot representations of rates of change of average conductivity of a hardware tool of a preferred embodiment; and

FIG. 7 is a chart representation of a method of a preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Hardware Tool for Authentication

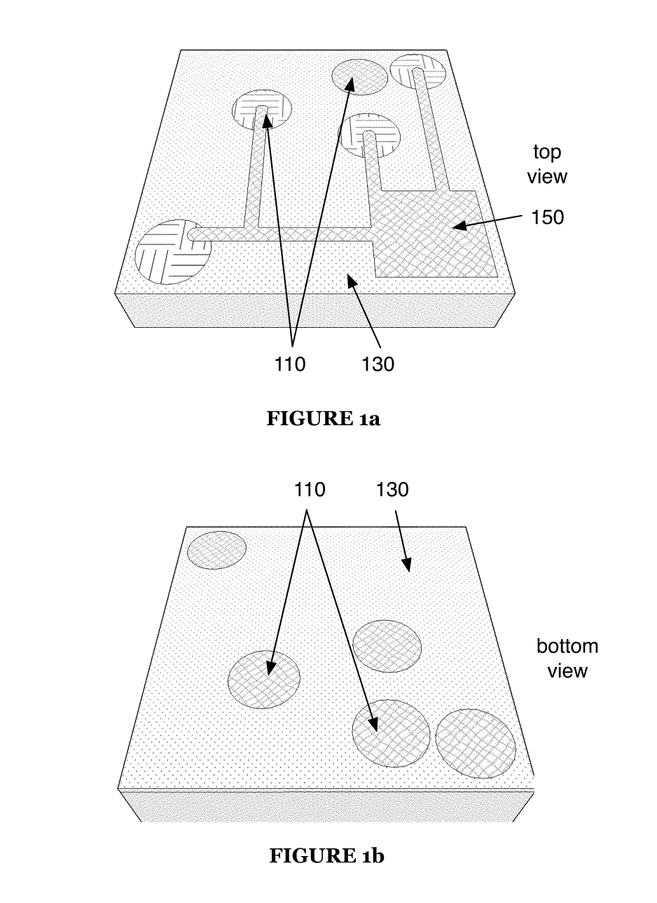

As shown in FIGS. 1a and 1b, a hardware tool 100 for authentication of a preferred embodiment includes capacitive interaction volumes 110, a substrate 130; and a current coupler 150. The hardware tool 100 may additionally or alternatively include a current sink 170 and/or a cover layer 190.

The hardware tool 100 preferably functions to enable authentication in conjunction with an electronic device having a capacitive touch sensor. For example, the hardware tool 100 could be used with the capacitive touchscreen of a computing device to authenticate a user, allowing access to the computing device. The computing device can be a smartphone, a tablet, a wearable computing device, a desktop computing device, a touchscreen computing kiosk, a remote control, a gaming device, and/or any suitable electronic device with a capacitive surface input. In some variations, the electronic device will have a touch sensor without a screen or optionally a touch sensor decoupled from a screen. Herein a phone is used for exemplary purposes, but any suitable electronic device having a capacitive sensor can alternatively be used. Authenticating a user's identity for information access is one example of authentication that can be enabled by the hardware tool 100, additional examples include authenticating a user's identity for transactions (for instance, transferring money, information, or digital goods from one party to another where the hardware tool 100 corresponds to one party), authenticating location (e.g. providing evidence that a transaction occurred at a specific place using a hardware tool 100 corresponding to that place), and authenticating digital goods (e.g. allowing access or transfer of digital goods to a party possessing a hardware tool 100 corresponding to those goods), and other suitable applications of the hardware tool 100 such as those found in U.S. patent application Ser. No. 13/385,049, which is incorporated in its entirety by this reference. The hardware tool 100 may additionally or alternatively function to trigger an event or action; for instance, pressing the hardware tool 100 to a phone screen may both initiate a transfer of money and authenticate the sending party. As another example, pressing the hardware tool 100 to the phone screen may enable an action in a game, for instance, firing a virtual weapon.

The hardware tool 100 preferably enables authentication and triggers events by causing capacitive interactions on a capacitive touch sensor of an electronic device. Features of these interactions, including their position (absolute or relative), timing, and/or magnitude identify the hardware tool 100 to the electronic device. Hardware tools 100 causing interactions having different properties are preferably distinguishable from one another. In one example, the hardware tool 100 has a pattern of capacitive interaction volumes 110. This pattern of capacitive interaction volumes 100 is identified as a number of touches at different locations on an electronic device with a capacitive touch sensor. The electronic device then compares the locations of the touches to a database (either local or remote), and upon matching the touch locations to a known pattern in the database, allows access. The electronic device can alternatively obtain a signature or unique identifier that is derived from the locations of the touches. The hardware tool 100 preferably can be used in conjunction with any electronic device having a capacitive touch sensor, but may alternatively be designed for use with specific electronic devices or specific types of capacitive touch sensors.

Using physical objects (e.g., the hardware tool 100) as authenticators may provide a number of advantages, including increasing authentication security, simplifying ownership transfers, and enhancing user experiences. Linking data to physical objects may also provide advantages for the physical objects; even static objects may, through their link to data, offer a dynamic experience. Further, the interaction between the physical object and the electronic device may provide further advantages; for example, if the electronic device is a geolocation-enabled smartphone, the transfer of data might be linked to a particular location as well as a particular physical object.

The hardware tool 100 may in particular provide advantages to the entertainment industry. Using the hardware tool 100, owners of a physical object incorporating the hardware tool 100 (e.g. a figurine, a toy) may, through electronic devices, access dynamic content specific to that object. Physical object manufacturers can control how the dynamic content links to an individual object owner in a number of ways. For instance, a sports figurine maker may create a series of Andrew Luck (an NFL quarterback) bobbleheads with unique authentication characteristics (i.e., each bobblehead is distinguishable from the others by the authentication process). Then, dynamic content can be tailored for each individual bobblehead. The sports figurine maker may also choose to make the bobbleheads with identical authentication characteristics or semi-identical authentication characteristics (e.g., batches sold in different countries have different authentication characteristics). In this case, the dynamic content may simply be linked to the bobblehead type and not to the individual owner. Alternatively, the manufacturer may use a combination of bobblehead type and other information (e.g. a user account) to tailor dynamic content to users.

The hardware tool 100 is preferably fabricated by injection molding, but may alternatively be fabricated by any other suitable manufacturing method; additive, subtractive, or otherwise. Applicable information on fabricating the hardware tool 100 by 3D printing is described in U.S. Provisional Patent Application No. 61/809,969, which is incorporated in its entirety by this reference.

The capacitive interaction volumes 110 function to interact with a capacitive touch sensor of an electronic device by changing a capacitance sensed by the capacitive touch sensor at at least one location. The capacitive interaction volumes no preferably are designed to be used with projected capacitive touch (PCT) sensing technology utilizing mutual capacitive sensors (used in multi-touch capacitive sensors) but may alternatively be designed to be used with PCT sensing technology utilizing self-capacitance sensors, with surface capacitance sensing technology, or with any other suitable capacitive sensing technology. The capacitive interaction volumes 110 are also preferably designed to be detected as human touch, but may alternatively be designed to be detected as distinct from human touch or may alternatively not be designed to be detectable at all.

For example, some capacitive sensors are able to distinguish between touch events by a finger and touch events by a stylus; the capacitive interaction volumes may be designed to mimic touch events by either the finger or the stylus.

In the case of PCT sensing technology utilizing mutual capacitive sensors, human touch is generally sensed by a drop in capacitance at the sensors; this drop in capacitance is caused by the flow of current away from the sensors (the human finger represents a conductive path to ground through which current may flow). Generally, the drop in capacitance must occur over a large enough area (i.e. over enough individual sensors) to be detected as a human touch. Each capacitive interaction volume 110 preferably corresponds to the touch of a single human finger; alternatively, there may be correspondence between any number of capacitive interaction volumes 110 and any number of finger touches or no correspondence at all. The capacitive interaction volume can alternatively correspond to the touch of any intended input device such as a stylus.

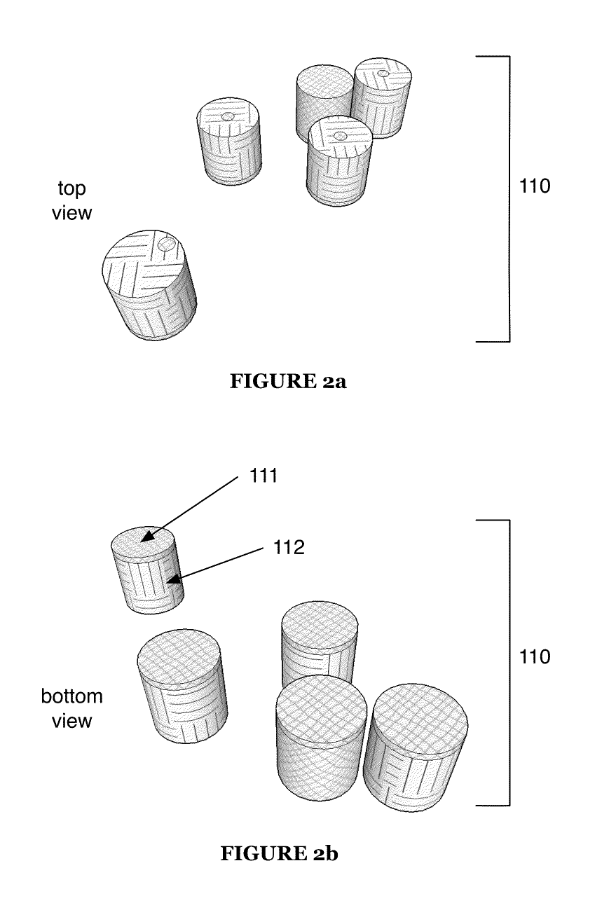

As shown in FIGS. 2a and 2b, each capacitive interaction volume 110 preferably has a capacitive contact area in and a capacitive body 112. The capacitive contact area 111 is preferably the area of the capacitive interaction volume no that comes into contact with or comes nearest to a capacitive touch sensor, and the capacitive body 112 is preferably the remainder of the capacitive interaction volume no. The capacitive contact areas in of all capacitive interaction volumes no preferably lie in a plane; all capacitive contact areas preferably can approach or contact a planar capacitive touch sensor at the same time. Alternatively, the capacitive contact areas 111 may be non-planar so that only some capacitive contact areas 111 contact a planar capacitive touch sensor for a given orientation of the hardware tool 100. The capacitive contact areas 111 are preferably circular, but alternatively may be of any shape. The capacitive contact areas 111 are preferably electrically isolated from each other by the substrate 130 (though they may be connected to the same current coupler 150 through their respective capacitive bodies 112) but alternatively may be electrically connected or may be isolated by air or any other non-conductive material. The capacitive contact areas 111 are preferably electrically conductive. The capacitive contact areas 111 may all be of the same material or may be of different materials. The material of each capacitive contact area 111 may vary spatially across the capacitive contact area. In one example embodiment, the material of the capacitive contact area 111 may be stippled, allowing for spatial variance.

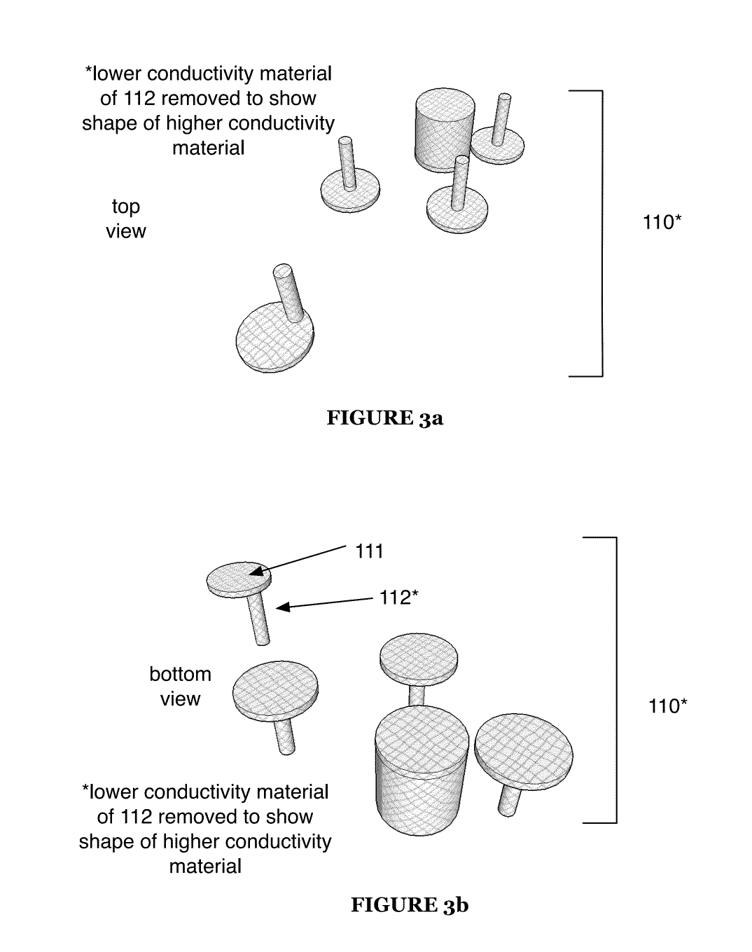

The capacitive body 112 is preferably coupled directly to the capacitive contact area 111 (i.e., the capacitive body 112 is preferably in contact with the capacitive contact area in). The capacitive body 112 is preferably composed of at least two structures composed of two different materials, one of which has a higher conductivity than the other. The capacitive body 112 may alternatively be composed of only one material or of many materials. The higher conductivity material of the capacitive body 112 is preferably the same material as the capacitive contact area in but may alternatively be any other suitable material. The lower conductivity material of the capacitive body 112 is preferably an electrical insulator but may alternatively be an electrical conductor or semiconductor. The materials of the capacitive body 112 preferably vary spatially; the spatial variance preferably corresponds to variance in the signal detected by a capacitive touch sensor. The capacitive body 112 is preferably a cylinder, but may alternatively be any three-dimensional shape. As shown in FIGS. 3a and 3b, the example implementations of the capacitive interaction volumes 110 of FIGS. 2a and 2b shown without their lower-conductivity materials highlight this spatial variance. This enables two hardware tools 100 with identical capacitive contact areas in and substrates 130 but different capacitive bodies 112 to present different signals when used in conjunction with a capacitive touch sensor (and thus be distinct from one another, while appearing to be visually identical). This allows for increased security (e.g., the hardware tool 100 could be not be replicated from a photograph of its capacitive contact areas in).

The capacitive interaction volumes 110 are preferably electrically connected to the current coupler 150 as shown in FIG. 1a. Alternatively, the capacitive interaction volumes 110 may be connected to any number of current couplers 150 or may not be connected to a current coupler 150 at all. In one example implementation, some capacitive interaction volumes 110 are connected to a first current coupler 150, some capacitive interaction volumes no are connected to a second current coupler 150, and some capacitive interaction volumes no are connected to both of the first and second current couplers 150. These current couplers 150 are then positioned such that a particular grip of the hardware tool 100 by a person results in the grounding of the first current coupler but isolation of the second current coupler, while an alternative grip of the hardware tool 100 by the person results in the grounding of the second current coupler but isolation of the first current coupler. In this way, the capacitive interaction between the hardware tool 100 and capacitive touch sensors may be influenced by how the hardware tool 100 is held (how grounding affects the capacitive properties of the hardware tool 100 is discussed in more detail in following paragraphs).

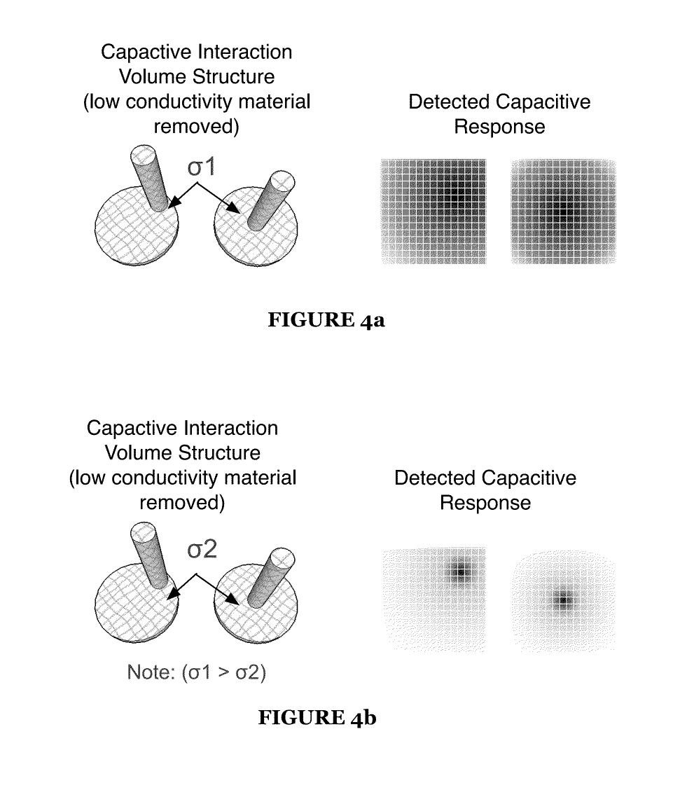

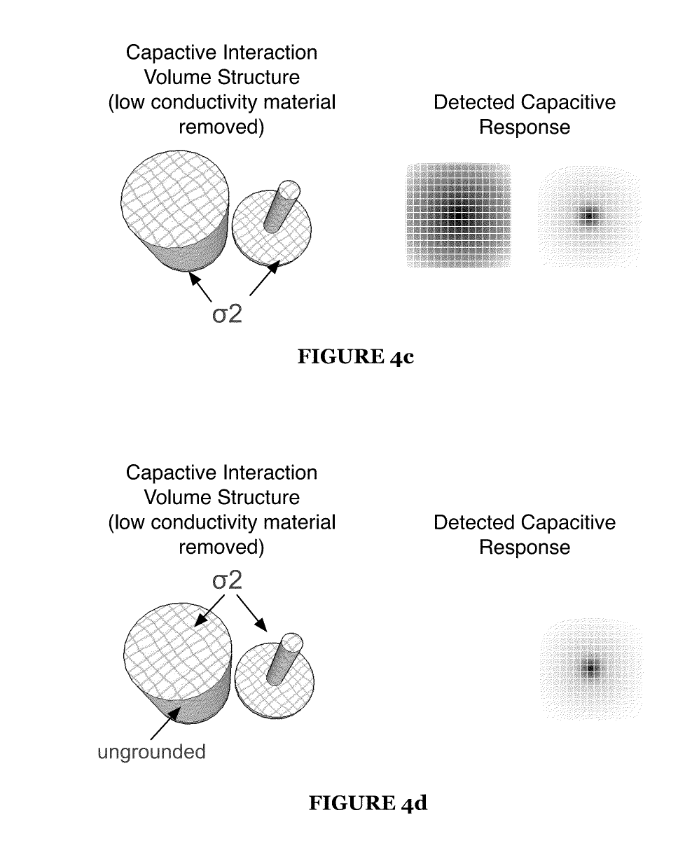

As shown in FIGS. 4a-4d, the capacitive interaction between each capacitive interaction volume 110 and a capacitive touch sensor preferably vary based on the materials of the capacitive interaction volume no, the spatial variance of those materials, and the presence and type of electrical connection to the capacitive interaction volume no. As shown in FIG. 4a and FIG. 4b, the conductivity of materials near the capacitive contact areas 111 affects the extent to which the capacitive body 112 can affect the signal detected by a capacitive touch sensor. In FIGS. 4a and 4b, all capacitive bodies 112 are electrically grounded. As shown in FIG. 4a, a very high conductivity results in little difference between the two structures as detected by the capacitive touch sensor. As shown in FIG. 4b, a lower conductivity results in a greater difference between the two structures. The capacitive interaction volumes 110 are preferably configured as in FIG. 4b so that both the capacitive contact area 111 and the capacitive body 112 affect the detected signal. Another example of this effect is shown in FIG. 4c; again both capacitive bodies 112 are electrically grounded. As shown in FIG. 4d, capacitive interaction volumes no are also affected by their electrical connections. In FIG. 4d, the right capacitive interaction volume is grounded and the left capacitive interaction volume is not electrically connected.

The capacitive interaction volumes no are preferably fabricated as part of the substrate 130, but may alternatively be attached to the substrate 130, embedded in the substrate 130, or coupled to the substrate 130 with any other suitable means. In a variation of a preferred embodiment, some capacitive interaction volumes 110 are fabricated as part of the substrate 130, but some capacitive interaction volumes 110 are added after fabrication of the substrate 130. This variation may be particularly useful in cases where reference interaction volumes (i.e., interaction volumes 110 corresponding to fixed reference points, for example, the corners of a capacitive interaction pattern) are desired along with variable interaction volumes (i.e., interaction volumes 110 corresponding to points that identify the hardware tool 100). Reference points may be particular useful for calibration purposes; the presence of reference points may enable the hardware tool 100 to operate on various touch sensors without a manual calibration step.

The substrate 130 functions to electrically isolate the capacitive interaction volumes 110 from one another and to provide mechanical support for the capacitive interaction volumes 110 and the current coupler 150. The substrate 130 is preferably an electrical insulator but may also be a semiconductor or any other suitable material. The substrate 130 may be fabricated of any number of materials. The substrate 130 is preferably solid, but may additionally or alternatively be hollow or partially hollow.

The substrate 130 may additionally function to provide separation between the capacitive contact areas in and the current coupler 150. This separation preferably prevents the structure of the current coupler 150 from affecting a sensed drop in capacitance. If the current coupler 150 (e.g., traces connecting the capacitive contact areas 111 to an external current sink) were in the same plane or in a plane close to the capacitive contact areas, the current coupler 150 may potentially interfere with the detection of the capacitive contact areas in. This may be especially problematic in situations where the current coupler 150 traces are smaller than a touch detection threshold (e.g., the minimum feature size of an object needed to trigger a human touch) but big enough to be detected by capacitive sensors; in these situations, the current coupler 150 may essentially serve to add noise to the detected capacitive interaction (e.g., shifting coordinates of detected touches). Further complicating the situation, the current coupler 150 may be more susceptible to variations in touch sensor detection characteristics than the capacitive contact areas 111 (e.g., the noise introduced may be highly dependent on not only the structure of the current coupler 150 but also on the particular model of touch sensor used). The current coupler 150 is preferably separated from the capacitive contact areas in by a distance of 2.5 mm or more, but may additionally or alternatively be separated from the capacitive contact areas in by any suitable distance (including zero distance).

The current coupler 150 functions to electrically couple one or more capacitive interaction volumes no to a current source or a current sink. The effect of each capacitive interaction volume no on a capacitive touch sensor is preferably dependent on the electrical connection to that capacitive interaction volume no. The current coupler 150 preferably functions to make electrical connections to the capacitive interaction volumes no. The current coupler 150 is preferably also connected to a current source or current sink, but may alternatively be unconnected. The current coupler 150 is preferably made of metal, but may alternatively be made of any conducting or semiconducting material. The current coupler 150 is preferably fabricated as part of the substrate 130 but may alternatively be fabricated separately.

In a first variation, the current coupler 150 is preferably unconnected and positioned so that when the hardware tool 100 is held by a person, the current coupler 150 electrically couples to the person. This electrical coupling preferably is direct contact of the skin to the current coupler 150, but may alternatively be indirect contact. This enables the person to serve as a current sink. When the current coupler 150 is electrically coupled to a person or other current sink, the capacitive interaction volumes no coupled to that current coupler 150 preferably provide a path for current to travel away from a capacitive touch sensor. For PCT sensing technology with mutual capacitance sensors, this causes a drop in capacitance, which can trigger a touch. When the same current coupler 150 is electrically isolated, the capacitive interaction volumes no coupled to that current coupler 150 can cause a raised capacitance for PCT sensing technology with mutual capacitance sensors, which may not be able to trigger a touch. In this embodiment, the hardware tool 100 preferably only enables authentication when held by a person (the person serving as a current sink) or connected to another current sink. The hardware tool 100 may have multiple current couplers 150 in different positions, for instance, to allow different patterns of capacitive interaction depending on how the hardware tool 100 is held.

In a second variation, the current coupler 150 is preferably directly connected to the current sink 170. In this embodiment, the capacitive interaction volumes no coupled to the current coupler 150 preferably could trigger a detected touch for PCT sensing technology with mutual capacitance sensors regardless of whether the hardware tool 100 was electrically coupled to an external current sink (e.g. a human). This would enable the hardware tool 100 to be used by a person wearing thick gloves, for instance, or by a person with a non-conductive artificial hand.

In a third variation, the current coupler 150 is preferably connected to a switch. The switch is preferably electronic (e.g. a transistor) but may alternatively be a mechanical switch. The switch is preferably also connected to a current sink, current source, or other circuitry. Turning the switch on and off preferably causes the capacitive interaction volumes no connected to the current coupler 150 to have different capacitive interactions with a capacitive touch sensor; allowing for different signals to be registered by the capacitive touch sensor based on the state of the switch. In one example, a number of current couplers 150 are hooked to a current sink indirectly through a microprocessor; the microprocessor opens and closes connections to the current sink to create a time-varying capacitance pattern on a capacitive touch sensor.

In a fourth variation, the current coupler 150 is electrically coupled to the exterior of the hardware tool 100. In this variation, the exterior surface (excepting electrically isolating areas between capacitive contact areas in) of the hardware tool is partially or completely covered in a conductive material (e.g., conductive paint), allowing for the creation of a low-resistance electrical path from the current coupler 150 to a person when the hardware tool 100 is held. The conductive material is preferably conductive paint, but may additionally or alternatively be any suitably conductive material (e.g., plated or sputtered metal). The conductive material is preferably exposed, but may additionally or alternatively be covered by a nonconductive material (e.g., non conductive paint). If the conductive material is covered with a nonconductive material, the non-conductive coating is preferably thin enough to still allow for touch-sensor triggering. This may result in an electrical path between the current coupler 150 that has significantly higher impedance at DC than at higher frequencies, but is still capable of causing touch screen triggering.

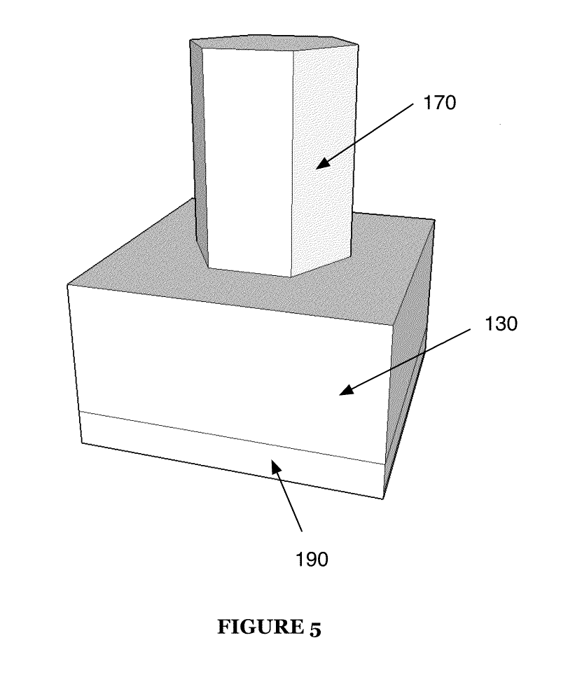

As shown in FIG. 5, the current sink 170 functions to provide a sink for current from the current coupler 150 to flow to. The current sink 170 preferably is configured to be seen as an electrical ground by a capacitive touch sensor near the hardware tool 100, i.e., the electrical potential of the current sink 170 is close to the electrical potential of the ground plane of the capacitive touch sensor, and current flowing into the current sink 170 from the capacitive touch sensor does not greatly change the electrical potential of the current sink 170. The current sink 170 is preferably a large conductive mass, but may alternatively be of any material or construction capable of providing a sink for current from the current coupler 150 to flow to such that the hardware tool 100 may trigger touch events on a capacitive touch screen without being electrically coupled to an external current sink or source. In one example, the current sink 170 is a metal handle for the hardware tool 100. In a second example, the current sink 170 is a metal wire connected to ground.

As shown in FIG. 5, the cover layer 190 functions to provide physical isolation between the capacitive contact areas in and the contact surface of the hardware tool 100. The cover layer 190 preferably provides protection for both the capacitive contact areas in and capacitive touch sensors. The cover layer 190 preferably also keeps capacitive contact areas in from being visible, providing an additional barrier to duplication of the hardware tool 100. The cover layer 190 is preferably made of a nonconducting or semiconducting material; e.g. plastic. The cover layer 190 is preferably planar, but may alternatively be any shape and configuration that covers at least some of the capacitive contact areas in of the hardware tool 100.

In an alternative embodiment, the capacitive interaction volumes no are composed of many small three-dimensional regions of conductive material embedded in the substrate 130. These regions vary in size, but are preferably smaller than 1 millimeter in any dimension. The regions preferably are also not in direct contact, but rather are separated by the material of the substrate 130 (or alternatively a different material of lower conductivity than the material of the regions). The regions are preferably distributed through the entire substrate in varying density. The regions are preferably distributed such that the conductivity of the substrate 130 (averaged over an area larger than the maximum dimensions of the regions) varies continuously over distance in all directions, as opposed to discontinuously. Alternatively, the conductivity of the substrate 130 may vary continuously over distance in more than one direction. The conductivity preferably does not vary dramatically over these scales measured at any point. This is distinct from a volume or area that has discontinuous conductivities over these scales (for instance, a layer having conductive areas and insulative areas of more than 1 square millimeter).

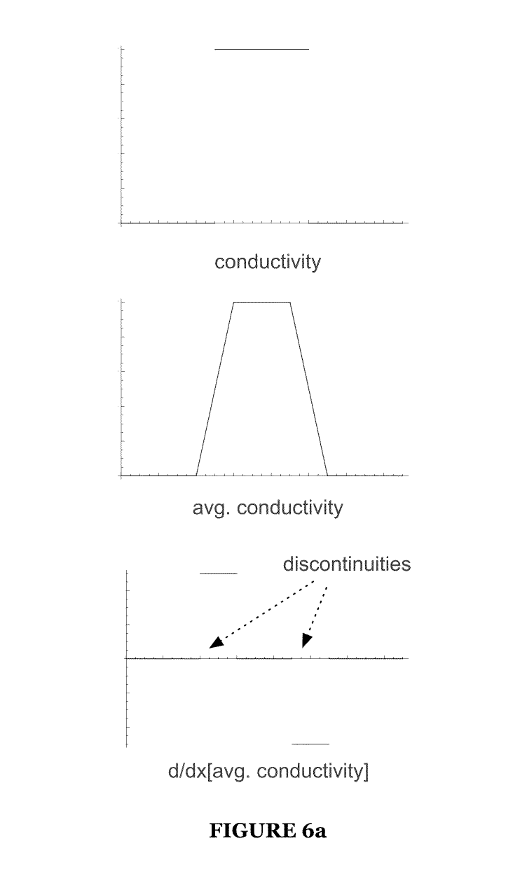

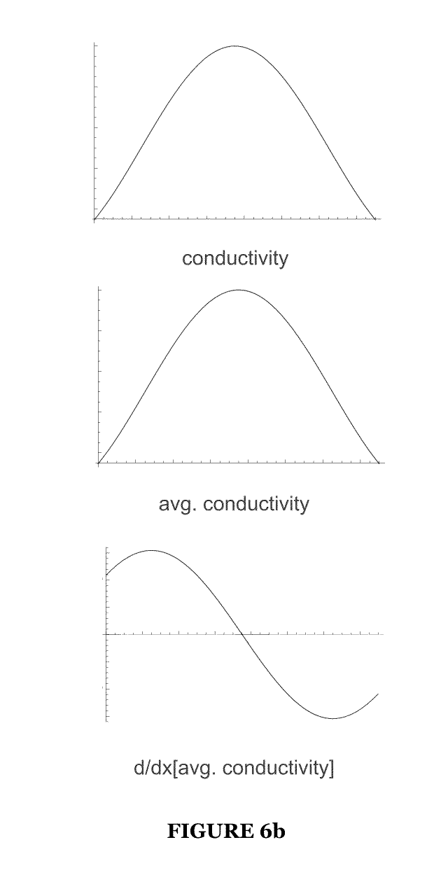

One way of ensuring that the conductivity does not vary dramatically is by placing restrictions on the rate of change of average conductivity. As shown in FIG. 6A, a structure with discontinuous conductivity on a particular length scale results in discontinuous rate of change of average conductivity (wherein rate of change is the derivative with respect to the x axis), while a structure with continuous conductivity on a particular length scale results in a continuous rate of change of average conductivity, as shown in FIG. 6B.

The conductivity preferably varies such that the effect on the capacitance of common capacitive touch panels is near a common detection threshold in many places (in some places above detection threshold and in other places below detection threshold). This is distinct from discontinuous regions (as previously described) of conductive and insulative materials; in this case, the regions of conductive materials (assuming they are grounded) should pass detection threshold and the regions of insulative materials should not. In this case, the detected pattern by a capacitive touch sensor would preferably vary highly based on its capacitive sensing threshold, even if that threshold were within normal range. In other words, the hardware tool 100 could preferably present a different touch pattern to different models of capacitive touch sensors. Further, the hardware tool 100 could also potentially present different touch patterns even to different touch sensors of the same model, depending on each touch sensor's calibration. This functions to add an additional level of security; in one example, the hardware tool 100 could not be used without the correct type of device (or even the specific correct device). Further, the hardware tool 100 would be very difficult to duplicate; someone desiring to duplicate the tool must either exactly replicate its conductive profile or know the calibration of the capacitive touch sensor the hardware tool 100 was meant to be used with.

The hardware tool 100 of the alternative embodiment is preferably fabricated by a 3D printing process, where the 3D printer can deposit at least two materials of different conductivity, and conductivity of the substrate 130 is preferably varied by varying the ratio of materials during deposition. Alternatively, the hardware tool 100 of the alternative embodiment may be fabricated by using shot peening or ion implantation of conductive materials on a lower-conductivity substrate 130 or by any other suitable manner.

### 2. Method for Authentication

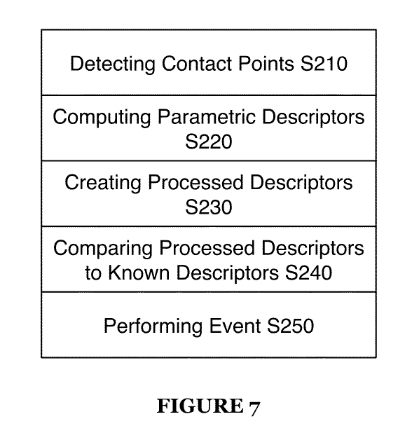

As shown in FIG. 7, a method 200 for authentication on an electronic device having a capacitive touch sensor includes detecting, on the capacitive touch sensor, a set of points of capacitive contact from a hardware tool S210, computing, from the set of points, a set of parametric descriptors S220, creating a processed set of parametric descriptors based on the set of parametric descriptors and characteristics of the capacitive touch sensor S230, generating a comparison of the processed set of parametric descriptors and a set of known parametric descriptors S240; and performing an event on the electronic device based on the comparison S250. The method 200 is preferably implemented by an electronic device having a capacitive touch sensor in cooperation with use of the hardware tool 100 described above, but the method 200 may alternatively be implemented using any suitable device and hardware tool 100.

The method 200 preferably functions to enable authentication on an electronic device with a capacitive touch sensor via a hardware tool. For example, the method 200 could be used to allow the hardware tool, when placed near the capacitive touch sensor, to authenticate a user, allowing access to the device. Authenticating a user's identity for information access is one example of a event that can be performed by the method 200; additional examples include authenticating a user's identity for transactions (for instance, transferring money, information, or digital goods from one party to another where the hardware tool corresponds to one party), authenticating location (e.g. providing evidence that a transaction occurred at a specific place using a hardware tool corresponding to that place), and authenticating digital goods (e.g. allowing access or transfer of digital goods to a party possessing a hardware tool corresponding to those goods). Further examples of authentications that could be performed using the method 200 are found in U.S. patent application Ser. No. 13/385,049. As additional examples of events that could be performed by the method 200, pressing the hardware tool to the capacitive touch sensor may both initiate a transfer of money and authenticate the sending party. As another example, pressing the hardware tool to the capacitive touch sensor may enable an action in a game, for instance, firing a virtual weapon.

Detecting, on the capacitive touch sensor, a set of points of capacitive contact from a hardware tool S210 functions to allow the capacitive touch sensor to detect the hardware tool. The capacitive touch sensor preferably interprets the hardware tool as a series of human touches; alternatively, the touch sensor may interpret the hardware tool as a more general profile of capacitance changes across the sensor or in any other suitable manner. The detection of the set of points preferably varies across different models of capacitive touch sensors.

Computing, from the set of points, a set of parametric descriptors S220 functions to generate a description of the detected points from the data taken by the electronic device. For example, if the data is just a set of coordinates, the parametric description is preferably a description of the positioning of the coordinates relative to a reference coordinate. The parametric description is preferably invariant of positioning of the hardware tool on the capacitive touch sensor (e.g. if the hardware tool contacts in the upper left corner of the device it should have the same parametric description as if it contacts the lower right corner of the device) but may alternatively be variant based on positioning. If the data includes more than touch coordinates, the parametric data preferably includes this additional data, but alternatively may not.

Creating a processed set of parametric descriptors based on the set of parametric descriptors and characteristics of the capacitive touch sensor S230 functions to create a data set that includes information both about the detected features of the hardware tool and the capacitive touch sensor that detected them. For hardware tools that are detected differently on different capacitive touch sensors, this information may be necessary for proper detection of the tool. Creating a processed set preferably includes appending known data on the capacitive touch sensor (e.g. model number of the sensor or the electronic device) to the set of parametric descriptors. Creating a processed set may additionally or alternatively include generating a calibration profile for the device, and then appending that calibration profile to the set of parametric descriptors.

Calibration profiles may be generated in a number of ways. For example, a calibration profile may be generated by detecting reference points of a hardware tool. Reference points are preferably features (e.g., capacitive interaction areas) of the hardware tool that retain a consistent relationship for all hardware tools. For example, a hardware tool may feature five points of capacitive contact, two of which are reference points. The reference points are identified as the two points having the largest separation between them; further, the reference points define a rectangular area in which the other points are positioned. Since the positioning of reference points is known ahead of time, a calibration profile for the hardware tool may be generated by comparing the detected reference point locations to the known reference point locations.

As another example, a calibration profile may be generated through other knowledge of the arrangement of capacitive interaction points of a hardware tool. For example, a hardware tool may be accompanied by an identifier code (e.g., a hash of parametric values). A user could enter this identifier into an application, the identifier can then be used to produce some information about the real location of capacitive interaction points on the hardware tool, which, when compared to detected locations, can be used to generate a calibration profile.

Creating a processed set may also additionally or alternatively include transforming the set of parametric descriptors based on characteristics of the capacitive touch sensor. For example, if a particular model of touch screen is known to be more sensitive along the x-axis than the y-axis, the parametric descriptors may be altered to account for this.

The characteristics of the capacitive sensor may be found in any suitable way. For example, characteristics of the capacitive sensor may be selected from a dataset based on an identifier of the electronic device (e.g., a model number). As another example, a user may manually enter characteristics of the capacitive sensor.

Generating a comparison of the processed set of parametric descriptors and a set of known parametric descriptors S240 functions to create a comparison between the processed set of parametric descriptors created in S230 and a set of known descriptors. For example, a smartphone may allow access when presented with a hardware tool if the set of processed parametric descriptors match a database of allowed descriptors. The set of known parametric descriptors preferably includes known parametric descriptors linked to capacitive touch panel information. Alternatively, the set of known parametric descriptors may be universal for all capacitive touch panels; this would be used if the processed parametric descriptors were transformed based on a reference set of touch panel characteristics. As another alternative, the set of known parametric descriptors may be computed in real-time from a combination of pre-set rules and touch screen characteristic data from the processed set of parametric descriptors. This comparison preferably occurs on the electronic device, but may alternatively occur in the cloud, on a server, or in any other suitable location.

Performing an event on the electronic device based on the comparison S250 functions to allow an event to be performed upon a match between the processed set of parametric descriptors and the set of known parametric descriptors. This event could be authenticating a transaction, unlocking the device to allow access, or any other event on the electronic device. This event may be performed by the native operating system of the electronic device or by an application running on top of the operating system, or in any other suitable manner.

The methods of the preferred embodiment and variations thereof can be embodied and/or implemented at least in part as a machine configured to receive a computer-readable medium storing computer-readable instructions. The instructions are preferably executed by computer-executable components preferably integrated with an electronic device having a capacitive touch sensor. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

We claim:

1. A hardware tool for authenticating with a capacitive sensor, the hardware tool comprising:
a set of capacitive interaction volumes, each of the set of capacitive interaction volumes comprising a conductive capacitive contact area and a capacitive body;
a dielectric substrate, coupled to the set of capacitive interaction volumes; wherein the dielectric substrate provides electrical isolation between capacitive interaction volumes of the set of capacitive interaction volumes; and
a current coupler, electrically coupled to the set of capacitive interaction volumes;
wherein proximity of the set of capacitive interaction volumes of the hardware tool to the capacitive sensor results in a detected change of capacitance at the capacitive sensor when the current coupler is electrically coupled to a current sink or current source.

2. The hardware tool of claim 1, further comprising a current sink electrically coupled to the current coupler.

3. The hardware tool of claim 1, wherein the dielectric substrate is partially hollow.

4. The hardware tool of claim 1, wherein the capacitive bodies of the set of capacitive interaction volumes comprises a first structure and a second structure; wherein the first structure electrically couples a capacitive contact area to the current coupler; wherein the first structure is fabricated of an electrically conductive material; wherein the second structure is fabricated of an electrically nonconductive material.

5. The hardware tool of claim 4, wherein the capacitive contact areas of the set of capacitive interaction volumes are substantially circular.

6. The hardware tool of claim 5, wherein the capacitive bodies of the set of capacitive interaction volumes are substantially cylindrical.

7. The hardware tool of claim 4, wherein the capacitive contact areas are arranged within a first surface; wherein the current coupler is arranged within a second surface; wherein the first surface and second surface are separated by a distance such that the shape of the current coupler does not affect the detected change of capacitance at the capacitive sensor.

8. The hardware tool of claim 7, wherein the distance is greater than 2.5 millimeters.

9. The hardware tool of claim 4, wherein the first structure is fabricated of an electrically conductive polymer; wherein the second structure is fabricated of an electrically nonconductive polymer.

10. The hardware tool of claim 4, further comprising a polymer cover layer covering the capacitive contact areas; wherein the current coupler is electrically coupled to a conductive layer on an exterior surface of the hardware tool.

11. The hardware tool of claim 10, wherein proximity of the set of capacitive interaction volumes of the hardware tool to the capacitive sensor results in a detected change of capacitance at the capacitive sensor when a human hand is in contact with the conductive layer.

12. A hardware tool for authenticating with a capacitive sensor, the hardware tool comprising:
a dielectric substrate having a first surface and a second surface; and
a plurality of conductive volumes located within the dielectric substrate;
wherein each of the plurality of conductive volumes is no larger than one millimeter in any dimension;
wherein proximity of the first surface of the dielectric substrate to the capacitive sensor results in a detected change of capacitance at the capacitive sensor when the second surface of the dielectric substrate is electrically coupled to a current sink or current source.

13. The hardware tool of claim 12, wherein each of the plurality of conductive volumes is no larger than one hundred microns in any dimension.

14. The hardware tool of claim 13, wherein a rate of change of average conductivity of the substrate varies continuously along a path parallel to the first surface; wherein the average conductivity is an average of conductivity values taken along a one hundred micron segment of the path.

15. A method for authentication on an electronic device having a capacitive touch sensor, the method comprising:
detecting, on the capacitive touch sensor, a set of points of capacitive contact from a hardware tool;
computing, from the set of points, a set of parametric descriptors;
creating a processed set of parametric descriptors based on the set of parametric descriptors and characteristics of the capacitive touch sensor;
generating a comparison of the processed set of parametric descriptors and a set of known parametric descriptors; and
performing an event on the electronic device based on the comparison.

16. The method of claim 15, wherein the characteristics of the capacitive touch sensor are selected from a dataset based on an identifier of the electronic device.

17. The method of claim 15, wherein creating a processed set of parametric descriptors comprises creating a device calibration profile and processing the set of parametric descriptors based on the device calibration profile.

18. The method of claim 17, wherein creating a device calibration profile comprises detecting reference points of capacitive contact from a hardware tool and generating the device calibration profile based on the reference points.

19. The method of claim 17, wherein creating a device calibration profile comprises receiving a hardware tool identifier and generating the device calibration profile based on the hardware tool identifier.

20. The method of claim 17, wherein performing an event on the electronic device comprises authenticating a user on the electronic device.
